(19) United States
(12) Patent Application Publication
(10) Pub. No.: US 2013/0144644 A1
(43) Pub. Date: Jun. 6, 2013

(54) CLINICAL TRIAL MANAGEMENT SYSTEMS AND METHODS

(71) Applicant: Peter Buchanan Simpson, Canterbury (AU)

(72) Inventor: Peter Buchanan Simpson, Canterbury (AU)

(73) Assignee: Biogenerics IP Development Pty Ltd., Camberwell East, Victoria (AU)

(21) Appl. No.: 13/640,306

(22) PCT Filed: Apr. 8, 2011
(86) PCT No.: PCT/AU2011/000406

§ 371 Date: Feb. 22, 2013

Related U.S. Application Data
(60) Provisional application No. 61/322,322, filed on Apr. 9, 2010.

(51) Int. Cl. G06F 19/00

(52) U.S. Cl. CPC G06F 19/36
USPC 705/2

(57) ABSTRACT

A method of managing a clinical trial where the clinical trial involves a follow-on biological (FOB) substance, the method comprising: receiving subject data at a computer system as the subject data becomes available, the subject data indicating effects of the administration of the FOB substance in the clinical trial; storing the subject data in a database; and making coded data electronically available to an authorised independent monitor, the coded data being based on the subject data and indicating effects of the administration of the FOB substance in the clinical trial but having subject-identifying information omitted therefrom, wherein the coded data is made available once the subject data is stored in the database.

This application claims priority to U.S. provisional application Ser. No. 61/322,322, filed 9 Apr., 2010, the entire contents of which is hereby incorporated by reference.

### TECHNICAL FIELD

The invention concerns clinical trial management systems and methods. In particular, methods and systems to be used in management of clinical trials concerning the efficacy of follow on biological (FOB) products.

### BACKGROUND

Generic pharmaceutical products have become an accepted and integral part of the worldwide pharmaceutical market, in essence because the generic products are considered identical, or bioequivalent to the respective innovator product.

It is possible to gain marketing approval for generic pharmaceutical products containing an active ingredient being a chemical or synthetic entity by proving that the innovator pharmaceutical product and the proposed generic equivalent are chemically the same, have the same formulation and are shown to be Pharmacokinetically equivalent. Once proved, the generic pharmaceutical manufacturer may rely on pre-clinical and clinical testing data of the innovator product, thereby saving significant time, resources and money. This is made possible in part because the majority of pharmaceutical products are small molecules. Such small molecules are generally synthesized using chemical reactions, are well-characterised and can be easily purified and analyzed with routine laboratory tests.

Follow-on-biologicals (FOBs), sometimes referred to as subsequent entry biologic products (SEBs), are products made through biotechnological means, and referable to an innovator biological product. Biologics are typically produced within specially engineered cells and larger biologics tend to be produced as diverse mixtures of molecules that differ very slightly from one another. This feature makes biologics difficult to characterise. Unlike small molecules, individual batches of biological products are heterogeneous at the molecular level, as a result of the random variability of the living process by which they were made, even if manufactured by a single manufacturer. By virtue of this inherent heterogeneity it is not always possible to analyse and specify products made by different manufacturers with sufficient precision to support the conclusion that they have identical clinical properties, even if they are indistinguishable by in vitro tests. Therefore the traditional generic pharmaceutical marketing approval pathway is not necessarily applicable for FOBs and challenging issues exist relating to the development, approval and marketing of FOBs.

Generic manufacturers of FOBs desire regulatory authorities to grant approval for their FOBs to be marketed as being “interchangeable”, or “substitutable”, with the innovator product. It is believed that only then will sufficient confidence in the FOB be generated that clinicians and national governments will support the interchangeability of the FOB with the innovator product or substitution of the FOB for the innovator product. This is considered possible because the direct result of an FOB being granted a status of “interchangeable”, or “substitutable” is that the FOB will be allocated the same International Nonproprietary Name (INN) as the innovator product. Each INN (otherwise referred to as the generic name or nomenclature) is a unique name that is globally recognized and is public property. It allows healthcare professionals and patients to identify a drug precisely and with confidence, and to avoid potentially serious adverse effects due to confusion between drugs.

Several FOBs have obtained marketing approval throughout the European Union. However the FOBs were registered on the basis that they produce a “similar” clinical outcome as the respective innovator product. This resulted in the requirement that for the purpose of marketing approval and subsequent sale, the FOBs receive a different INN to that of the respective innovator.

It is desired to address or ameliorate one or more shortcomings or disadvantages associated with existing clinical trial management systems or methods, or to at least provide a useful alternative thereto.

### SUMMARY

Some embodiments relate to a method of managing a clinical trial where the clinical trial involves a follow-on biological (FOB) substance, the method comprising:

receiving subject data at a computer system as the subject data becomes available, the subject data indicating effects of the administration of the FOB substance in the clinical trial;

storing the subject data in a database; and

making coded data electronically available to an authorised independent monitor, the coded data being based on the subject data and indicating effects of the administration of the FOB substance in the clinical trial but having subject-identifying information omitted therefrom, wherein the coded data is made available once the subject data is stored in the database.

The subject data may not be made available to the authorised independent monitor.

The method may further comprise processing the subject data or the coded data to determine non-inferiority or equivalence of the FOB to an innovator biologic substance. The method may further comprise determining non-inferiority of the FOB substance if the coded data or subject data indicate that effects of the FOB substance are within a pre-specified non-inferiority margin relative to the innovator biologic substance. The determining may comprise computing a confidence interval on π_{Innovator}-π_{FOB} based on a null hypothesis of π_{Innovator}≦π_{FOB}−δ and comparing an upper bound of the computed confidence interval to −δ, where δ is the non-inferiority margin, π_{FOB} is the success rate of the FOB substance and π_{Innovator} is the success rate of the innovator biologic substance. The confidence interval may be a two-sided α-level confidence interval.

The authorised independent monitor may be independent of management of the clinical trial and may be authorised to instruct termination of the clinical trial where, during the clinical trial, the authorised independent monitor determines that the coded data indicate inadequate effects from the administered FOB substance.

Making the coded data available may comprise transmitting the coded data to the authorised independent monitor. The coded data may be transmitted in response to a request from the authorised independent monitor.

Making the coded data available may comprise allowing the authorised independent monitor on-demand access to the coded data.

Receiving the subject data at a computer system may comprise receiving the subject data at a server system in communication with one or more computers at a site conducting the clinical trial. The subject data may be input to the one or more computers at the site for communication of the subject data to the server system over a network. The server system may perform the storing and making available.

The authorised independent monitor may comprise a monitor computer system in communication with the server system over a network.

The method may further comprise enrolling screened trial subjects into the clinical trial and conducting the clinical trial. The clinical trial may be a non-inferiority trial or an equivalence trial.

The method may further comprise processing the coded data or the subject data to determine whether, as the subject data is received during the clinical trial, the coded data or subject data indicate inadequate effects from the administered FOB substance.

Some embodiments relate to a computer implemented method to conduct a clinical trial, the method comprising:

storing clinical trial data of subjects in an ongoing clinical trial that concerns the efficacy of a follow-on biological (FOB); and

providing an independent monitor with substantially continual access to the clinical trial data, whereby said independent monitor may monitor whether said clinical trial data meets predetermined criteria.

A condition of ongoingness of the clinical trial may be conditional on the clinical trial data having been determined to meet the predetermined criteria.

The method may further comprise performing statistical analysis on said clinical trial data. The method may further comprise determining a margin of non-inferiority of the FOB and determining whether effects of the FOB are within the margin of non-inferiority.

The clinical trial data is stored in a database as it is made available from the clinical trial and the clinical trial data is made available to the independent monitor. The clinical trial may be a non-inferiority trial or an equivalence trial.

Some embodiments relate to a system used in managing a clinical trial where the clinical trial involves trialling a follow-on biologic (FOB) substance, the system comprising:

a computer system to receive subject data as the subject data becomes available, the subject data indicating effects of the administration of the FOB substance in the clinical trial; and

a database storing the subject data;

wherein the computer system has access to the database to store and retrieve the subject data and controls access to the database; and

wherein the computer system is configured to make coded data electronically available to an authorised independent monitor, the coded data being based on the subject data and indicating effects of the administration of the FOB substance in the clinical trial but having subject-identifying information omitted therefrom, wherein the computer system is configured to make the coded data available to the authorised independent monitor once the subject data is stored in the database.

The computer system may not make the subject data available to the authorised independent monitor. The computer system may be configured to process the subject data or the coded data to determine non-inferiority or, equivalence of the FOB to an innovator biologic substance. The computer system may be configured to determine non-inferiority of the FOB substance if the coded data or subject data indicate that effects of the FOB substance are within a pre-specified non-inferiority margin relative to the innovator biologic substance. The computer system may determine non-inferiority by computing a confidence interval on π_{Innovator}-π_{FOB} based on a null hypothesis of π_{Innovator}≦π_{FOB}−δ and comparing an upper bound of the computed confidence interval to −δ, where δ is the non-inferiority margin, π_{FOB} is the success rate of the FOB substance and π_{Innovator} is the success rate of the innovator biologic substance. The confidence interval may be a two-sided α-level confidence interval.

The authorised independent monitor may be independent of management of the clinical trial and may be authorised to instruct termination of the clinical trial where, during the clinical trial, the authorised independent monitor determines that the coded data indicate inadequate effects from the administered FOB substance.

The computer system making the coded data available may comprise the computer system transmitting the coded data to the authorised independent monitor. The computer system may transmit the coded data in response to a request for the coded data received from the authorised independent monitor.

The computer system making the coded data available may comprise the computer system allowing the authorised independent monitor on-demand access to the coded data.

The computer system may comprise a server system in communication with one or more computers at a site conducting the clinical trial. The subject data may be input to the one or more computers at the site for communication of the subject data to the server system over a network. The authorised independent monitor may comprise a monitor computer system in communication with the server system over a network. The clinical trial may be a non-inferiority trial or an equivalence trial.

The computer system may be further configured to process the coded data or the subject data to determine whether, as the subject data is received during the clinical trial, the coded data or subject data indicate inadequate effects from the administered FOB substance.

Some embodiments relate to a computerized clinical trial management system, the system comprising:

a database storing clinical trial data of subjects in an ongoing clinical trial concerning the efficacy of a follow-on biological (FOB); and

a server coupled to the database, said server being configured to enable an independent monitor substantially continual access to the database to obtain subject data in order to determine whether such subject data meets predetermined criteria, the subject data being based on the clinical trial data, wherein the condition of ongoingness of the clinical trial is conditional on the subject data having been determined to meet the predetermined criteria.

The system may further comprise a network interface coupled to the server to enable the independent monitor to communicate with the clinical trial management system over a network. The server may be further configured to notify the independent monitor when new trial data becomes available.

Some embodiments relate to a system comprising means for performing any of the methods described herein or for implementing any of the systems described herein.

Some embodiments relate to computer-readable storage for clinical trial management, said computer-readable storage storing computer-executable instructions, said instructions when executing on a computer system causing the computer system to perform any of the methods described herein or to implement any of the systems described herein.

Some embodiments relate to computer-readable storage for clinical trial management, said computer-readable storage storing computer-executable instructions, said instructions when executing on a computer system causing the computer system to perform a method comprising:

storing clinical trial data of subjects in an ongoing clinical trial that concerns the efficacy of a follow-on biological (FOB); and

providing an independent monitor with substantially continual access to subject data, whereby said independent monitor may monitor whether said subject data meets predetermined criteria.

Some embodiments relate to a computer implemented method to conduct a clinical trial, the method comprising:

storing clinical trial data of subjects in an ongoing clinical trial which concerns the efficacy of a follow-on biological (FOB); and

providing an independent monitoring body with substantially continual access to subject data so as to determine whether such subject data meets predetermined criteria;

wherein the condition of ongoingness of the clinical trial is conditional on the subject data having been determined to meet the predetermined criteria.

The clinical trial may be a non-inferiority trial or the clinical trial may be an equivalence trial.

If the results from a clinical trial find non-inferiority or equivalence of an innovator biologic product and the FOB, then the FOB may be deemed to be interchangeable with the innovator biologic product. It is considered that deeming an FOB as interchangeable with an innovator biologic product will directly result in greater access to biologic-based drug products or substances than is otherwise available because approval to label the FOB with the same INN will be possible.

As will be appreciated by those skilled in the relevant art, the term. ‘min-inferiority’ is well established and is distinct from superiority trials (which are not considered suitable for FOBs) and equivalence trials. A non-inferiority trial aims to demonstrate that the FOB is not worse than the innovator product by more than a pre-specified, small amount. This amount is known as the non-inferiority margin, or delta (δ). In contrast, equivalence trials are designed to confirm the absence of a meaningful difference between the FOB and the innovator product. In the case of equivalence trials, a margin of clinical equivalence (Δ) is selected by defining the largest difference that is clinically acceptable so that a difference exceeding this would in practice matter.

In accordance with some embodiments, the method may further comprise performing statistical analysis on at least certain of the subject data. Statistical analysis may be based on confidence intervals. For a non-inferiority trial, statistical analysis may be based on a one-sided or two-sided confidence interval. For an equivalence trial, statistical analysis is preferably based on a two-sided confidence interval. Equivalence is inferred when the entire confidence interval falls within the equivalence region defined by [−Δ,+Δ].

The method may further comprise determining a margin of non-inferiority (δ). The margin of non-inferiority (δ) may comprise clinical and statistical considerations. The margin of non-inferiority (δ) may be pre-specified.

In a non-limiting example where the margin of non-inferiority (δ) is pre-specified, a test of non-inferiority may take a null statistical hypothesis: π_{Innovator}≦π_{FOB}−δ, where πᵢₙₙₒᵥₐₜₒᵣ and π_{FOB} are the success rates for the FOB and innovator. The statistical test may be invoked by computing a two-sided α-level confidence interval on π_{Innovator}−π_{FOB} and comparing the upper bound to −δ.

The margin of non-inferiority may vary with underlying success rates of the FOB.

Trial data may be stored in a database as it is made available. The trial data may be coded prior to being stored.

In accordance some embodiments, the method may further comprise determining a population sample size for the clinical trial. The method may further comprise screening a potential trial subject to determine whether the subject meets requisite criteria to participate in the clinical trial. The method may further comprise enrolling a successfully screened trial subject in the clinical trial.

In accordance with some embodiments, the method may further comprise recording clinical trial data of subjects (e.g. in a computer system) and transmitting the clinical trial data set over a network. The clinical trial data may be coded prior to transmitting the data over the network. The method may further comprise receiving the transmitted clinical trial data of subjects on a substantially continual basis (i.e. as it becomes available to be transmitted from the computer system at which it is recorded). The method may, further comprise pushing/transmitting subject data (preferably coded) from the database to the independent monitoring committee. The subject data (preferably coded) may be pushed/transmitted on demand.

As described above, the step of performing statistical analysis may include determining a margin of non-inferiority as described above. Alternatively, or in addition, the step of performing statistical analysis may include multi-way analysis of variance upon the subject data. The method may further comprise pushing/transmitting statistically analysed data to the independent monitoring committee. Alternatively, or in addition, the method may further comprise pushing/transmitting raw data to the independent monitoring committee for subsequent statistical analysis.

The method may further comprise notifying the independent monitoring committee when new clinical trial data becomes available.

The method may further comprise generating reports of the status of the trial and forwarding the reports to the independent monitoring committee.

The transmitted clinical trial data may be blinded so as to obscure a subject's identity.

In some embodiments, the clinical trial may involve a cross-over study with an innovator biological product and a FOB to determine whether non-inferiority exists. The cross-over clinical study may be blinded to a treating physician and a trial sponsor. The method may further comprise randomly allocating a sequence to a subject, where the sequence is representative of the order in which the innovator biological product and the FOB are administered to the subject.

Some embodiments relate to a computerised clinical trial management system, the system comprising:

a database storing clinical trial data of subjects in an ongoing clinical trial concerning the efficacy of a follow-on biological (FOB);

retrieval means operatively coupled to the database and configured to enable an independent monitoring committee substantially continual access to the database to receive subject data in order to determine whether such subject data meets predetermined criteria; and

a network interface operatively coupled to the retrieval means to enable the independent monitoring committee to communicate with the clinical trial management system over a network;

wherein the condition of ongoingness of the clinical trial is conditional on the subject data having been determined to meet the predetermined criteria.

The database may comprise a relational database. Preferably trial data is stored in the database as it becomes available. Preferably the trial data is coded prior to being stored.

The clinical trial management system may comprise a processor operatively coupled to the database, the retrieval means and the network interface.

The clinical trial management system may further comprise an analysis module executable by the processor and operable to perform statistical analysis on at least certain of the (preferably coded) subject data.

The clinical trial management system may further comprise a network coupling said network interface to the independent monitoring committee. The network coupling may further couple said network interface to one or more source sites. Source sites may be hospitals and/or clinical centres, or the like, for collecting trial data. The network may be a wide area network such as the Internet. The network may comprise a wireless telephone network, a wired telephone network, a wireless communications network or a wired communications network.

The retrieval means may further comprise means for transmitting/pushing subject data from the database to the independent monitoring committee. Transmitted/pushed subject data may be raw data or may be statistically analysed data. The clinical trial management system may be configured to transmit/push subject data as soon as it is received, i.e, on demand. Optionally the clinical trial management system may be configured to notify the independent monitoring committee when new trial data becomes available.

The system may further include a reports module executable by the processor and operable to generate reports of the status of the trial. The retrieval means may transmit the reports of the status of the trial to the independent monitoring committee.

The reports module may be operable to generate messages to personnel concerning actions to take to advance the trial. Such personnel may form part of the independent monitoring committee.

The system may further include a site management module for indicating the conditions at certain geographical locations, including the portion of any protocol to be carried out in that geographical location.

Predetermined criteria may include whether the FOB is determined to be interchangeable or substitutable with an innovator product. The criteria may include time-based considerations.

Some embodiments relate to computer-readable storage storing software for implementing the described methods and systems.

Management of a clinical trial in the described manner may be advantageous where the aim of the clinical trial is to show that an innovator biological product and a FOB are interchangeable by conducting an equivalence or non-inferiority trial as described herein. An example of a protocol for such a clinical trial is described in detail below, with reference to Neupogen as an example of an innovator biological product and Neukine as an example of a FOB.

An advantage of at least some embodiments is that adverse effects of a treatment which may otherwise go unnoticed until the clinical trial is well into the study, or possibly even complete, are substantially prevented. This is in part made possible due to the independent committee's analysis of subject data occurring continually, or at least frequently, while the actual trial is ongoing. This can mitigate ethical issues that may be associated with running the trial, which can be a key factor in being able to run the trial in some countries.

It is anticipated that by following the described methodologies, assuming the results of such a clinical trial are successful (that is that the FOB is determined to be equivalent to the innovator product, or not worse than the innovator product by more than a pre-specified amount), the relevant regulatory authority will register the FOB in accordance with the current respective regulatory regime. Such a result is advantageous as legislative changes may be unnecessary.

### BRIEF DESCRIPTION OF THE DRAWINGS

Embodiments are described by way of example with reference to the accompanying drawings, in which:

FIG. 1 is a functional block diagram of a clinical trial management system in accordance with some embodiments;

FIG. 2 illustrates a table showing the schedule of assessments which will be performed in a particular clinical study; and

FIG. 3 is a flowchart of a method of managing a clinical trial according to some embodiments.

### DETAILED DESCRIPTION

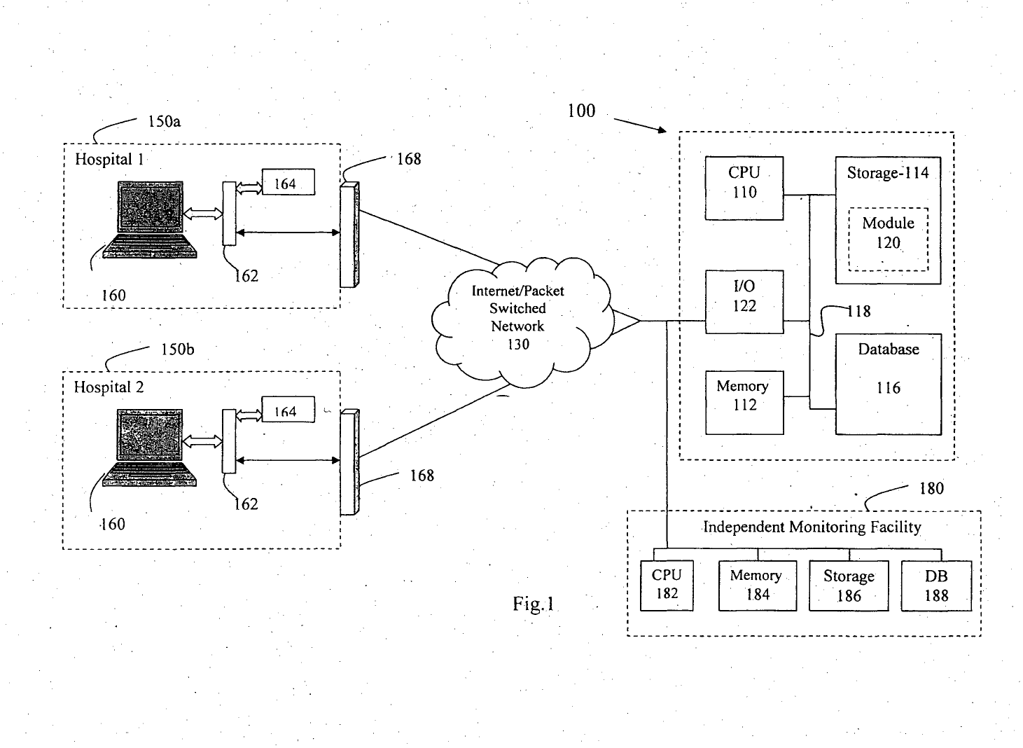

FIG. 1 illustrates a clinical trial data management system 100 of the present invention which automates data collection, communication, statistical data analysis and external monitoring and regulation of the clinical trial whilst a trial is ongoing. The clinical trial data management system 100 comprises a general purpose, programmed computing device or computer system, such as a server system, having at least one processor, such as a central processing unit (CPU) 110, memory 112, program storage 114, and a database 116, all commonly communicatively connected to each other through a bus 118. Database 116 may comprise integrated (local) or physically separate (optionally distributed) data storage for system 100. The program storage 114 stores, among others, program code modules that include a statistical analysis module 120. The statistical analysis module 120 may analyse the subject data and calculate the relevant values to enable interpretation of statistical significance of the subject data.

Memory 112 is any memory sufficiently large to hold the necessary programs and data structures. Memory 112 could be one or a combination of memory devices, including Random Access Memory, non-volatile or backup memory, (e.g., programmable or Flash memories, read-only memories, etc.) In addition, memory 112 may be considered to include memory physically located elsewhere in the computer system 100, for example, any storage capacity used as virtual memory or stored on a mass storage device (e.g., direct access storage device 114 or database 116) or on another computer coupled to (and in communication with) the computer 100 via bus 118. Thus, memory 112 and storage device 114 could be part of one virtual address space spanning multiple primary and secondary storage devices.

The database 116 stores patient/subject data on a substantially continual basis (i.e. as it becomes available) throughout the clinical trial. Any of the software program modules in the program storage 114 and data from the database 116 are transferred to the memory 112 as needed and is executed/processed by the processor 110.

The clinical trial data management system 100 may further include non-volatile secondary storage such as a hard drive or CD ROM drive, network interfaces and peripheral devices including user interface means such as a keyboard and display (none of which are shown).

The clinical trial data management system 100 is connected to a data communications wide area network (WAN) 130, such as the Internet, through the I/O interface 122. Through the network 130 the clinical trial data management system 100 communicates with a plurality of local sites, or hospitals 150a, 150b to receive subject data from one or more clinical trials. Each of the local sites, or hospitals 150a, 150b, generally referred to as a hospital site 150 includes work management stations 160 (for example, a nurse's computer workstation or clinical physician's computer workstation) having a customized interface and a browser, a local area network (LAN) 162, a local data store 164 and firewall 168 to couple the respective local site 150 to the network 130. Firewall 168 may run, security protocols and/or screen incoming and outgoing data for malicious code such as computer worms or viruses. Each hospital site 150 stores data acquired from its subjects in its local data store. Work management station 160 is used by an operator such as a nurse, for manually inputting subject data from a locally run trial or it can be operated in an automated manner, for example to communicate with a wireless tablet computing device on the LAN into which the data is input by clinical staff. The workstation may be a desktop PC, a laptop or handheld tablet PC or similar computing device.

As data becomes available, for example by entry at computer workstations 160, it is checked for integrity (i.e. by comparison with acceptable bounds), coded and stored to the local database. Simultaneously the coded subject data is routed over the network 130 to the clinical trial data management system 100 where it is stored in database 116. The stored and transmitted subject data is coded (i.e. encoded) in the sense that the data is de-identified, such that all identifying information that would enable a person to readily ascertain the identity of the individual to whom the information pertains and the drug to which they have been assigned, has been replaced with a code (number, letter, symbol or combination thereof). This is important from both a statistical and an ethical and privacy perspective.

The clinical trial data management system 100 is in communication with a computer system 180 of an authorised independent monitoring body/analysis facility. The computer system 180 of the independent facility has a central processing unit (CPU) 182, memory 184, program storage 186, and a database 188, all commonly connected to each other through a bus. The clinical trial data management system 100 is configured to enable the independent monitoring body 180 on-demand access to the system's database 116 to determine whether data collected during the clinical trial meets predetermined criteria.

Clinical trial management system 100 may use existing computer architecture, possibly run by a server system comprising one or more servers, operating custom software to perform the functions described herein. In particular, the software configures the computer system to process and store the clinical trial data, creating data records for each subject participating in the clinical trial and managing access to the data within those records in order to provide independent monitoring system 180 with appropriate oversight on the conduct of the clinical trial by allowing access to the underlying data regarding effects of the FOB on the participating subjects.

Rules dictating the routing of subject data to the independent monitoring facility 180 depend on the facility's specifications. In one example, the facility 180 may specify that statistical analysis is to be performed on the subject data prior to pushing the data to the computer system 180. In other embodiments, the analysis may be carried out by computer system 180 as an alternative or in addition to the analysis being performed by the analysis module 120.

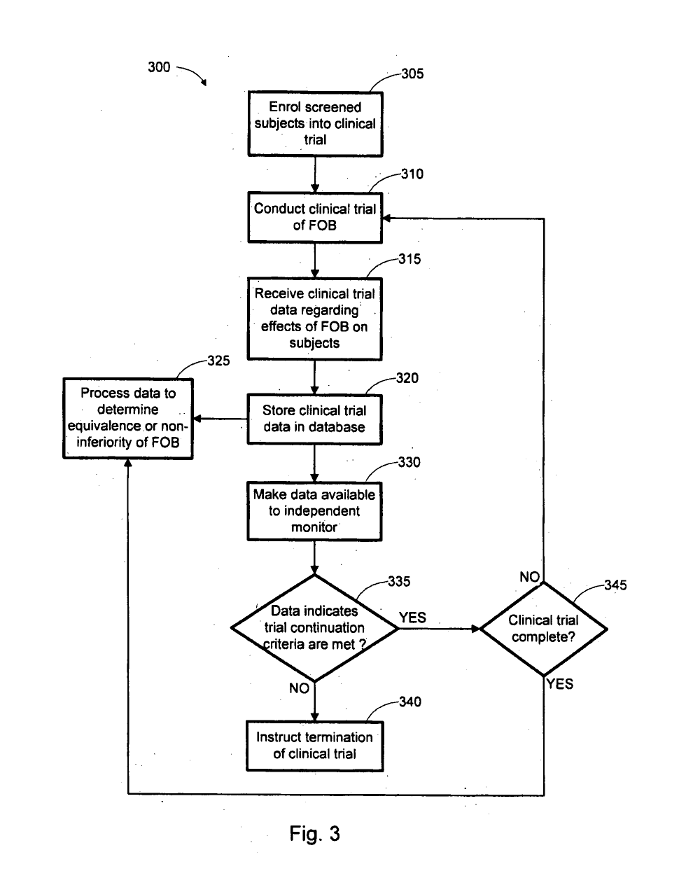

Referring also to FIG. 3, a method 300 of managing a clinical trial of a FOB, where the trial is to determine equivalence or non-inferiority of the FOB relative to an innovator biological. Method 300 may begin at 305, in which prospective subjects for the clinical trial are screened and enrolled into the trial. Once the subjects are enrolled into the trial, the clinical trial is conducted at 310, during which the FOB may be administered as part of a cross-over study with the innovator biological, as described herein.

As the trial is ongoing, clinical trial data is received at 315, where the data indicates the effects of the FOB and optionally also the innovator biological on the subjects during the trial. This clinical trial data is stored in database 116 and optionally also data stores 164 of the hospital computer systems 150, at 320. The stored clinical trial data is processed at 325 by analysis module 120 (and optionally also equivalent modules in computer systems 150 and 180) to determine equivalence or non-inferiority of the FOB, either on an interim or final basis, depending on the state of progress of the trial.

At 330, data in the database 116 is made available to the computer system 180 of the authorised independent monitor. As previously, discussed, the data made available may be coded data that has subject identifying data stripped or otherwise omitted therefrom, in order to protect the subjects' privacy. In some instances, the clinical trial data received at clinical trial management system 100 from the hospital sites at which the trial is being conducted may have already been coded to remove subject identifying data. Thus, the original and complete clinical trial data may be stored in databases associated with the hospital computer systems 150.

Making the clinical trial data available at 330 may involve notifying the authorised independent monitor 180 of the availability of the data for receipt or upload or, alternatively, the server system of clinical trial management system 100 may simply make the data stored in database 116 regarding the effects of the FOB available at any time to the authorised independent monitor for electronic querying or receipt thereof. Clinical trial management system 100 may be configured to transmit batches of new and/or old clinical trial data to system 180 as it becomes available and/or in response to a specific request for such data.

At 335, the software executing at the computer system 180 of the authorised independent monitor processes the received clinical trial data to determine whether continuation criteria for the clinical trial are indicated by the data as being met. For example, such criteria may include preset tolerances regarding acceptable effects of the FOB on the subjects. Where the clinical trial data is determined at 335 by computer system 180 of the authorised independent monitor to not be met, the authorised independent monitor may instruct the termination of the clinical trial at 340. Otherwise, if the continuation criteria are met at 335, then at 345, if the clinical trial is not complete, acts 310 to 335 are repeated. Otherwise, if the clinical trial is determined to have been completed, then at 325 the full clinical trial data from the conduct of the trial is processed at 325 to determine equivalents or non-inferiority of the FOB.

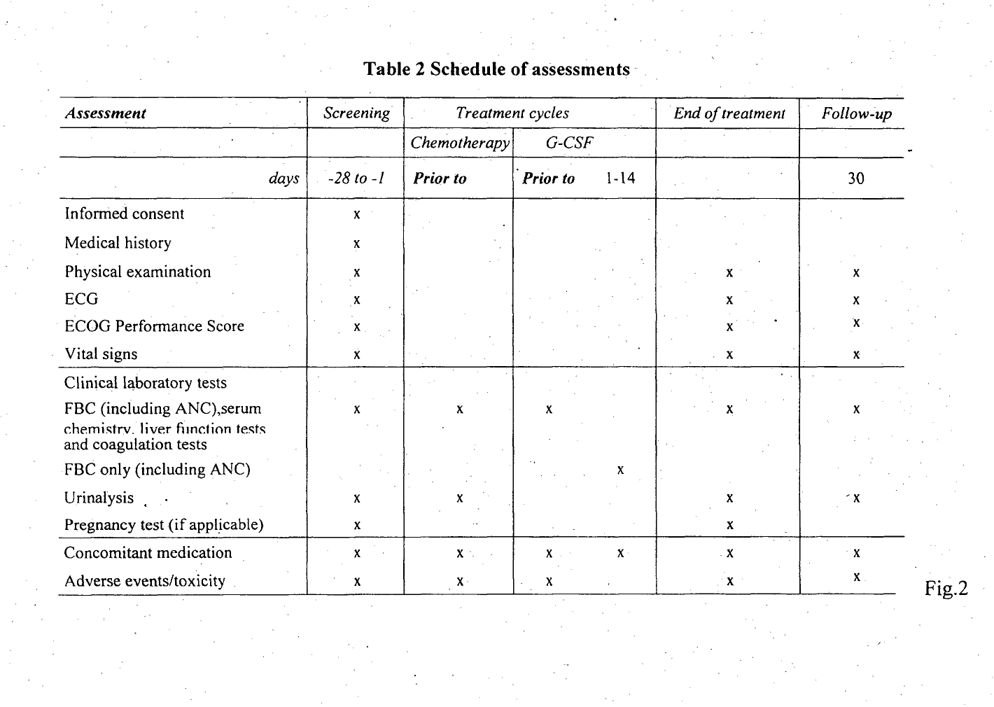

A clinical trial protocol to be conducted in Australia, in accordance with embodiments is described below by way of example only and illustrated with general reference to FIG. 2. The protocol discusses first study objectives, followed by selection of the study population, treatments and study procedures, efficacy evaluations and endpoints, safety evaluations, ethics, data analysis and statistical considerations and reporting of study results.

The clinical trial protocol described below is an example of a clinical trial that can be managed by the described methods and systems and this provides supporting details regarding features, functions and uses of the described embodiments.

The described arrangements and methods are particularly addressed to issues regarding conduct of trials to investigate the efficacy of FOB substances, where the trial is to determine equivalence or non-inferiority of the FOB. In such trials, a doctor offering two alternative drugs, one of which might be the same, but is not being offered on the basis that it is superior to the other, will be presented with an ethical dilemma. The described systems and methods assist in mitigating such a dilemma by allowing effects of the administration of the FOB (as a putatively equivalent or non-inferior biological) to be monitored closely, for example on a daily basis, so that any disparity in medical equivalence of the biologicals is known very quickly.

In previous clinical trial management techniques, it may take in the order of three to six or more months in order to determine any disparity in medical equivalence, by which time substantial deleterious effects may have been experienced by subjects participating in the trial. Techniques described herein also allow disparities in medical equivalence that are determined to fall outside of preset parameters to be flagged, so that immediate action can be taken, for example by the hospital conducting the trial, by the trial sponsor or by the independent monitor. Thus, each of computer systems 100, 150 and 180 may execute software in order to flag any such disparity falling outside of the preset equivalents parameters, in order to be able to take corrective action as necessary. Techniques described herein also more readily allow the approval of ethical aspects of a proposed clinical trial for equivalence or non-inferiority because of the rapid dissemination of clinical trial data and frequent ongoing analysis of that data during the trial in order to be able to take corrective action quickly.

### 1. Study Objectives

The primary aim with the study is to demonstrate comparable clinical efficacy, i.e. non-inferiority of Neukine® as compared to Neupogen® in preventing chemotherapy induced neutropenia (<0.5×10⁹/L). The secondary aims are to demonstrate, comparable rates of received dose-intensity in subjects with solid tumours receiving myelosuppressive chemotherapy, and gain relevant information regarding the use of Neukine® as part of the treatment protocols associated with solid tumours.

### Study Rationale

This proposed clinical study will compare the efficacy and safety of two G-CSF products, manufactured using essentially the same technologies at different sites. Both products are of the same formulation and are packaged in syringes. Each G-CSF product complies with the same Pharmacopoeial standards (USP and EP). The study will compare G-CSF currently available in Australia (Neupogen®) with G-CSF produced in India (Neukine®). The latter product (Neukine®) offers a considerable price reduction compared to Neupogen®.

The study seeks to verify that there is no clinical significant difference between either of the products, i.e. to confirm non-inferiority of the two products.

In addition, it is expected that confirmation of the non-inferiority of the two G-CSF products under study will allow the use of a significantly cheaper G-CSF in various dose-dense regimens to be actively considered for a much wider range of tumour types than is currently the case.

The consequences of chemotherapy induced neutropenia include febrile neutropenia (FN), hospitalization, infection related morbidity and mortality, delays in the administration and resultant decrease in chemotherapy dose intensity. Dose reductions or delays have the potential to compromise treatment efficacy in responsive and potentially curable malignancies. In addition to the detrimental effect on clinical outcomes, these consequences of neutropenia create a substantial economic burden and negatively impact subject quality of life (QOL).

If these products are shown to be clinically equivalent, i.e., Neukine® is not worse than Neupogen®, it is expected that the wider use of G-CSF as either adjuvant or prophylactic therapy in systemic cancer chemotherapy might therefore become economically justifiable.

Importantly, the current selective use of this drug because of cost constraints might become obsolete allowing for clinical decisions to be made on the basis of efficacy, clinical benefit and need—rather than cost.

### BACKGROUND

—Chemotherapy and Received Dose Intensity

Chemotherapy comprises an, essential component of the standard of care for most solid tumours as well as haematological malignancies. It improves survival in adjuvant and palliative settings, improves quality of life whilst ameliorating symptoms from disease but has significant toxicities that need to be balanced against the potential benefits. Chemotherapy also used in patients suffering from certain advanced autoimmune diseases.

Maximally effective delivery of evidence-based chemotherapy is achieved if sufficient dose of chemotherapy is delivered within the appropriate time interval to the individual patient. The dose and timing of chemotherapy is determined from phase I and II clinical studies where the major dose-limiting toxicity for determining these parameters is myelosuppression. There is no evidence for the routine use of high-dose chemotherapy, i.e. doses above the maximum tolerated doses, in the management of patients with solid tumours.

Multiple studies have reported the benefits of optimal received dose intensity defined in terms of dose delivered over time (e.g. mg/m2/wk) and an arbitrary level of 85% or greater than the defined dose intensity from the published report is considered acceptable. By analogy, dose intensity less than this level has been reported to deliver inferior outcomes in terms of response rates, disease-free and overall survival.

The major reason for reducing treatment dose or delay treatment delivery is myelosuppression secondary to the cumulative myelosuppressive effects of chemotherapy. These effects can be ameliorated by red cell or delivery of human recombinant erythropoietic factors for anaemia, platelet transfusions for thrombocytopenia and delivery of human recombinant G-CSF for neutropenia.

—Myelosuppression and Chemotherapy Risks

Myelosuppressive chemotherapy and the associated risk of neutropaenic sepsis may result in significant morbidity, prolonged hospitalisation and death. Cytotoxic therapy-induced myelosuppression and the associated risk of infection vary with receipt of average relative dose-intensity of chemotherapy of >85% of the chemotherapeutic regimen. In addition, the risk of opportunistic infection is directly related to the duration of severe neutropenia with the greatest risk occurring within the first two cycles of chemotherapy.

Other factors which have been reported to affect the risk of febrile neutropenia (FN) whilst receiving cytotoxic chemotherapy include age >65 years, tumour burden, absolute neutrophil count (ANC) of <1.5×10⁹/L at diagnosis, baseline serum albumin of <35 g/L at diagnosis, and the presence of additional medical co-morbidities at baseline.

Overall mortality rates from febrile neutropenia in adults receiving cytotoxic chemotherapy are <5%—Antibiotic therapy for FN has undergone a steady evolution in the past 25 years. Prior to the routine use of empirical antibiotic therapy, mortality during FN was as high as 40% and Gram-negative sepsis predominated. Despite modern diagnostic techniques, the site of infection is identified in only approximately 40% of patients. Where an organism is documented, the pattern of infection in patients with febrile neutropenia has changed over the past 30 years with a steady shift towards Gram positive infections, although Gram-negative infections remain the commonest cause of morbidity in febrile neutropenia.

The published American Society of Clinical Oncology (ASCO), The National Comprehensive Cancer Network (NCCN) and European Society of Medical Oncology (ESMO) guidelines have attempted to generalise these risks associated with each of the described chemotherapy regimens, however, clinical judgment must be employed to integrate these other risk factors in decisions regarding delivery of cytotoxic chemotherapy.

—Risk Factors Associated with the Development of Febrile Neutropenia

The EORTC guidelines have detailed risk factors associated with the development of febrile neutropenia including older age, advanced stage of disease, previous febrile neutropenia and lack of previous exposure to G-CSF and/or antibiotics. Hence their group recommends: that the risk of complications related to FN should be assessed individually for each patient. When assessing FN risk, the clinician should take into account patient-related risk factors (recommendation 1), the chemotherapy regimen and associated complications (recommendations 2 and 3) and treatment intent (recommendation 3). If the patient is at >20% overall risk of febrile neutropenia, prophylactic G-CSF is recommended. When using chemotherapy regimens associated with a febrile neutropenia risk of 10-20%, particular attention should be given to the assessment of patient characteristics that may increase the overall risk of febrile neutropenia.

—Granulocyte Colony Stimulating Factors and Treatment of Neutropaenic Sepsis

Almost forty years ago the relationship between the circulating neutrophil count and the risk of pyogenic infection was established. Since that time, multiple clinical trials have identified the causes, risk factors, pathogenesis, and natural history of first and subsequent febrile neutropaenic episodes. Refinements to the empirical antibacterial management have reduced infection-related mortality to less than 10 percent.

The standard of practice for the management of febrile neutropaenic cancer patients includes a rapid clinical evaluation to identify a clinical focus of infection and a pathogen, selection of monotherapy versus combination therapy; and prophylaxis, which involves, among other strategies, quinolone use, prevention of fungal and viral infections, surveillance cultures, prevention of catheter-related infections, and vaccines, and in-hospital intravenous administration of broad-spectrum antibacterial therapy. Persistently neutropaenic patients initially responsive to empirical antibacterial therapy had a 41% rate of recrudescence unless the antibacterial regimen is continued until neutrophil recovery >0.5×10⁹/L.

The timing of the first febrile neutopaenic episode in patients receiving a given cycle of cylotoxic therapy is correlated with the nadir of the neutrophil count and with the instrumental damage due to the effects of cytotoxic regimen on the intestinal mucosal epithelium. The median time for onset of the febrile neutropaenic episode is day 12 from the first day of the current cycle of cytotoxic therapy.

Febrile neutropaenic cancer patients form a very heterogeneous population with respect to the risks for complications that require prolonged hospitalisation. Such complications involve the requirement for critical care services, to cope with hemodynamic instability, hypotension, and respiratory insufficiency; symptom control of pain, nausea, vomiting, and diarrhoea; altered mental status and delirium; reduced performance status; haemorrhage requiring blood product transfusion; cardiac dysrhythmia requiring monitoring and treatment; and changes in renal function requiring intervention and treatment modifications,

Many attempts have been made to discriminate high-risk and low-risk patients presenting with fever and neutropenia. The expectation for response, defined by defervensence, varies with the risk group. The median time-to-defervensence for high-risk patients treated with appropriate empirical antibacterial regimens is of the order of 5 days. In contrast, the expected time-to-defervescence among low-risk patients has been of the order of 2-3 days

In particular, recombinant G-CSFs have been shown to reduce the severity and duration of chemotherapy-associated FN. Two major international groups, ASCO and NCCN, provide extensive clinical practice guidelines for oncology treatments. Both of these groups have current published guidelines regarding the use of Myeloid Growth Factors in cancer treatment. The use of G-CSF is recommended by ASCO in situations where chemotherapeutic regimens that are associated with 40% or greater chance of febrile neutropenia whilst the more recent guidelines from NCCN recommend this cut-point is 20%.

The NCCN guidelines have been formulated on the basis that: “Over the past decade, the costs of inpatient hospitalization have escalated, changing the risk threshold on a pure cost basis from 40% to 20%.

—Granulocyte Colony Stimulating Factors and Prevention of Neutropaenic Sepsis

The 2006 ASCO guidelines for the use of prophylactic G-CSF changed markedly with the recommendation that its use be extended to encompass therapy when the risk of febrile neutropenia is approximately 20% rather than 40% as in the 1996, 1997, and 2000 guidelines. The NCCN also recently revised their guidelines in favour of the same 20% febrile neutropenia threshold for a definite indication of G-CSF prophylaxis and included a 10% to 20% febrile neutropenia threshold range indicating optional G-CSF prophylaxis. These changes were based largely on the results of two new phase III clinical trials that show G-CSF are effective when the risk of febrile neutropenia is approximately 20%.

In the first study, Vogel et al. compared patients receiving adjuvant chemotherapy for early breast cancer with or without pegylated G-CSF; the risk of febrile neutropenia was reduced from 17% without to 1% with G-CSF, and the risk of hospitalization for febrile neutropenia was reduced from 14% without to 1% with G-CSF.

A second study by Timmer-Bonte et al. showed that the risk of febrile neutropenia in small cell lung cancer (SCLC) patients at high risk of febrile neutropenia could be reduced from 24% to 10% in cycle 1 by adding G-CSF.

Prevention of pyogenic bacterial infections in high-risk patients by the administration of prophylactic oral antimicrobial agents has been widely studied with mixed success, largely related to the changing epidemiology of bacterial infections towards Gram-positive infections and the prevalence of resistance of pathogens targeted by the chemoprophylaxis strategy.

Randomised clinical trials have demonstrated the efficacy of G-CSF in reducing the rate of febrile neutropenia when administered prophylactically to cancer patients receiving chemotherapy.

—Granulocyte Colony Stimulating Factors and Cost

In 1996, the American Society of Clinical Oncology published a list of important clinical outcomes in cancer care including the following: improvements in overall, or disease-free survival; improvement in quality of life; reduced toxicity; and improved cost-effectiveness. Previous studies have shown both clinical efficacy and cost neutrality with G-CSF use after intense chemotherapy regimens with febrile neutropenia risks of 40% or higher to decrease the threshold to 20% rates of FN.

Whilst the use of G-CSF to reverse the chemotherapy induced neutropenia is common in the treatment of breast cancer; it is not routinely used in either an adjuvant or prophylactic setting for the management of other solid tumours. This is predominantly because of cost constraints.

Indeed, the currently available treatment regimens for a number of solid tumours have been formulated with a keen eye for the cost of such therapies. It is also worth noting that the policy of the NCCN Guidelines panel, is to look “primarily at issues of therapeutic efficacy and clinical benefit, rather than at cost”. As noted in the NCCN guidelines, when societal costs are considered, the economic impact of febrile neutropenia becomes greater, and the cost saving benefits of G-CSF are more apparent. Furthermore, economic models that consider not just direct medical costs, but also indirect costs to society (i.e. productivity-related costs), have been developed that require us to reassess the level of risk at which prophylactic use of G-CSFs may be appropriate.

Recent cost-minimisation studies have evaluated the economics of peg G-CSF and have included the total costs of FN care and the potential for outpatient treatment of FN. Incorporation of non-medical, indirect and intangible costs, which can be half as much as the total direct medical costs, into the G-CSF decision models can decrease the febrile neutropenia risk threshold projections.

The reality is that the very high price of G-CSF is a major health care issue and has significantly constrained its use.

The economic benefit of administering G-CSF to many patients is not considered justifiable at this time even though there is ample Category 1 evidence to suggest that numerous clinical benefits are likely to accrue. Both clinical practice guidelines referred to previously acknowledge that the increased use of myeloid growth factors such as g-CSF could be justified if they cost significantly less.

—Cost of Therapy

As discussed above, received dose-intensity significantly impact on survival parameters in both the palliative and adjuvant setting of treating patients with cytotoxic therapy. In such cases; where neutropenia is anticipated or has occurred, and PBS reimbursement is not permitted, the treating oncologist either reduces the chemotherapy doses or extends the cycle times between chemotherapy administration in order to deliver therapy safely, i.e. reducing the risk of potentially life-threatening neutropenia. Neither is in the best interests of the patient, where the standard of care prior to the introduction of G-CSF cannot continue as part of routine therapy because of the requirement to effectively manage drug costs. There seems to be little or no consideration of the difficulties faced by the hospitals providing therapeutic support, the treating oncologists or the patients when treatment schedules have to be rearranged because of insufficient neutrophil recovery.

Neukine®, manufactured by Intas, has been shown to be equivalent to Neupogen® in all pre-clinical testing conducted thus far, as well as likely to provide a considerable cost advantage over Neupogen®, bringing it well into the range of the ‘accepted’ cost/QALY of AUD $60 000.

If shown to be clinically similar to Neupogen®, the use of Neukine® will allow the economics of the treatment protocols for non-myeloid tumours and AML to be brought into line with the clinical imperatives associated with myelosuppression control.

### Study Endpoints

The primary parameter for investigation will be time to restoration of absolute neutrophil count (ANC)>1.5×10⁹/L or the duration of Grade 4 Neutrophilia (ANC<0.5×10⁹/L) following chemotherapy Cycle 1.

Secondary parameters include duration of hospital stay due to neutropenia without fever and prevention of neutropenia subsequent to first episode.

Other efficacy endpoints include the duration of Grade 4 neutropenia in chemotherapy cycles 2-4, the depth of the nadir in each of the cycles and the time to ANC recovery (ANC 1.5×10⁹/L) in cycles 1 to 4.

Various other parameters will also be measured, including the presence of infection, antibiotic usage, hospitalization requirements, time between chemotherapy cycles and side effects.

### 2. Selection of Study Population

Subjects are initially screened to determine whether or not they meet the defined criteria.

### Inclusion Criteria

Subjects meeting all of the following criteria will be considered for admission to the study:
Histologically or cytologically confirmed diagnosis of non myeloid malignancies receiving myelosuppressive anti-cancer drugs or Acute Myeloid Leukaemia receiving induction or consolidation chemotherapy;
Chemotherapy naive or adjuvant therapy only or only one chemotherapy regimen for metastatic disease which in the opinion of the treating physician the risk of developing febrile neutropenia is >20%;
Subjects must be more than 3 weeks from any prior surgery (except for central line placement) and have fully recovered from the effects of surgery.
Subjects must be >18 years of age;
Subjects must have an estimated life-expectancy of at least 6 months;
Subjects must be able to understand the risks and benefits of the study and give written informed consent to participation;
Subjects at diagnosis must have: acceptable renal and hepatic function evidenced by a serum creatinine <1.5 mg/dl and serum transaminase levels AL T≦2.5× the upper limit of normal for the reference laboratory, bilirubin <20 μlmol/L, and adequate haematological function defined by ANC≧1.5×10⁹/L, WCC>3×10⁹/L, platelet count ≧100×10⁹/L and haemoglobin >12.0×gm/L;
Subjects must be able and prepared to return to clinic for follow-up visits;
Subjects of childbearing potential must agree to use an acceptable method of contraception; and
ECOG Performance Status <2.

### Exclusion Criteria

Subjects presenting with any of the following will not be included in the study:
Subjects who are on a concurrent investigational drug study or who have had any treatment with any investigational agents within four weeks of commencing the study;
Subjects with active infection who received systemic anti-infective therapy within 72 h of chemotherapy;
Prior lifetime exposure to doxorubicin >240 mg/m² or epirubicin >600 mg/rn².
Subjects who are on a concurrent radiation therapy;
Subjects with Leukaemia with the exception of acute myeloid leukaemia.
Subjects with a known allergy to g-CSF or its excipients;
Subjects who are on a concurrent corticosteroid use;
Subjects with identifiable immune system disorder such as Multiple Sclerosis, Systemic or Lupus, Erythematosis;
Subjects who have received immunosuppressive therapy in the past 12 months;
Subjects with evidence of human immunodeficiency virus (HIV) infection;
Subjects with active hepatitis or liver cirrhosis as defined by elevated liver function enzymes.
Subjects with medical or psychiatric conditions, which in the opinion of the Investigator would compromise the subject's ability to participate in the study;
Subjects with concurrent severe and/or uncontrolled medical disease (e.g. uncontrolled diabetes, hypertension, ischemic heart disease, congestive heart failure, etc.);
Subjects who have not recovered from the acute effects of any prior anti-neoplastic therapy or radiotherapy; or
Subjects who are pregnant or lactating.
   Removal, Replacement or Early Withdraw of Subjects from Therapy or Assessment

Subjects who withdraw before the end of the study due to study agent toxicity will not be replaced. Subjects who withdraw for any other reasons will be replaced in order to evaluate the toxicity profile of any of the therapy. Subjects who withdraw from the study will be asked to return after one-month for the post-study visit for clinical evaluation including physical examination, clinical laboratory tests and adverse event assessment.

### Protocol Violation Procedures

—Definition of a Protocol Violation

Protocol violations include any deviations from this protocol, regardless of prior approval of the violation. A major protocol violation would include the following:
Enrolment of a subject who does not meet the inclusion/exclusion criteria.
Enrolment of a subject who has not signed an informed consent form.
Not reporting serious adverse events (SAEs) according to the procedure described in the protocol.

—Reporting Protocol Violations

All protocol violations found at the site will be reported to the Sponsor. Major protocol violations must be reported to the Sponsor as soon as the Investigator or the Independent Monitor becomes aware of them.

### Study Design

The proposed study is a double-blind randomized study. The schedule of assessments which will be performed in the study during each treatment cycle is given in the Table illustrated in FIG. 2.

—Enrollment Procedures

All pre-screened subjects considered to be at significant risk of developing significant neutropenia, will be referred to the institution for cytotoxic therapy and will be eligible for enrollment provided that they meet the eligibility criteria.

—Randomization to Study Treatment

Randomisation of which G-CSF is to be delivered will occur on the day of commencement of cytotoxic therapy. This assignment will be blinded to the treating physicians and the trial sponsor. The two sources of G-CSF injection will be designated Drug A or Drug B. The subjects will be randomly allocated using computer generated random numbers to a sequence (ABAB, ABBA, BAAB, BABA, AABB or BBAA) and will receive either Drug A or Drug B in accordance with their randomization sequence. Coded labelling will be managed by the research pharmacist. The sequence to which each subject is assigned is recorded against the respective subject's entry in the database 164.

—Study Treatment

The subject will receive full dose chemotherapy in accordance with standard current practice. Chemotherapy will be repeated every 3-4 weeks depending on the current practice for up to four cycles. G-CSF will be given daily starting on the day after cytotoxic therapy has been completed until the post chemotherapy nadir has passed and their ANC is greater than 1.5×10⁹/L or up to Day 14, whichever occurs first.

Cycle 1 of Chemotherapy:

Prior to administration (within 2 hours) of the first of the chemotherapy drugs in Cycle 1 blood and urine will be collected for analyses.

The day after cytotoxic therapy has been completed; subjects will receive either Drug A or Drug B in accordance with the randomisation at an initial dose of 5 μg/kg/day administered daily SC. This is rounded UP to the nearest syringe size.

All subjects will undergo a Full Blood Count (FBC) including the ANC analysis on this day prior to the start of treatment with G-CSF. The duration of G-CSF therapy required to produce an ANC>1.5×10⁹/L will vary, depending on the myelosuppression potential of the chemotherapy protocol. Blood samples will be collected daily on days 1 to 14 following start of G-CSF administration for the analysis of absolute neutrophil count to determine the efficacy of the treatment.

As is usual therapeutic practice, subjects will be administered either Drug A or Drug B daily until the post chemotherapy nadir has passed and their ANC is greater than 1.5×10⁹/L or up to Day 14, whichever occurs first.

At that stage the G-CSF treatment will cease for that cycle of chemotherapy and the subject will be assigned to their next cycle of chemotherapy. If the ANC is not >1.5×10⁹/L after 14 days of treatment with Drug A or Drug B then G-CSF will be stopped and the subject will be considered as a treatment failure. From that point onwards the subject will continue to receive their chemotherapy in accordance with standard current practice.

Cycles 2 to 4 of Chemotherapy:

Immediately prior to, on the day of, the each cycle of chemotherapy blood and urine will be taken as per the protocol outline (Appendix A). On the day following the completion of each cycle of chemotherapy, the subjects will have a Full Blood Analysis including ANC, determined. The subject will subsequently receive G-CSF as per the previous dosage (5˜g/kglday administered daily as a single SC injection). In accordance with the protocol, these subjects will receive will receive either (Drug A) or (Drug B) in accordance with their randomization sequence.

Blood samples will be collected daily on days 1 to 14 following start of G-CSF administration for the analysis of ANC.

As is usual therapeutic practice, subjects will be administered either Drug A or Drug B daily until the post chemotherapy nadir has passed and their ANC is greater than 1.5×10⁹/L or up to Day 14, whichever occurs first.

—Dose Adjustments and Modifications

A 25% dose reduction in chemotherapy treatment will be permitted in case subjects experience grade 3 or 4 nonhematopoetic toxicities, two grade 3 or 4 infectious episodes or grade 4 thrombocytopenia.

If on the day of treatment for cycles 2-4 of chemotherapy the ANC is >10×10⁹/L then 3 possible explanations include: 1) residual effects of Cycle G-CSF, 2) intercurrent infection, 3) intercurrent corticosteroid use has elevated the ANC.

The effects of these three explanations should balance out across the randomised treatment arms and should not interfere with treatment delivery, should the subject and investigator be happy to continue trial participation.

—Study Duration

The study will continue until the required number of subjects has been accrued, unless the Data Monitoring Safety Committee considers there is a reason for cessation of the study.

—Therapy after Study Period

There shall be no proscribed therapy after the study period is complete, nor will further G-CSF be supplied.

### Study Evaluations

—Efficacy

Blood will be collected prior to G-CSF administration and thereafter daily from day 1 of G-CSF treatment until the post chemotherapy nadir has passed and their ANC is greater than 1.5×10⁹/L or up to Day 14, whichever occurs first.

—Safety and Tolerance

Clinical Laboratory Studies

Blood and urine samples will be collected at screening, on day 1−time=2 h prior to first dose of chemotherapy in each chemotherapy cycle, at the end of treatment and at a 30 day post-study visit. Blood tests should be done more frequently in the event of significant toxicity at the discretion of the Investigator.

Blood will be analysed for the following: Full blood count-FBC (i.e.: red blood cells, haemoglobin, haematocrit, MeV, MCH, reticulocytes, leucocytes (total and differential) and platelets), Serum chemistry panel (i.e: sodium, potassium, calcium, phosphate, chloride, bicarbonate, blood urea nitrogen, creatinine, glucose, and cholesterol (total, LDL, HDL)), Liver Function Tests, (i.e: total protein, albumin, bilirubin (total), aspartate transaminase (AST), alanine transaminase (ALT), alkaline phosphatase (ALP), INR and APTT); Urinalysis (i.e: Dipstick tests for pH, protein, glucose, ketones, bilirubin, blood, urobilinogen, nitrite and leukocyte esterase.)

Physical Examination

Physical examinations for each subject will be performed at screening, at the end of treatment and at the post-study visit.

Vital Signs

Height (at screening only), weight, blood pressure and pulse rate, respiration rate and body temperature and an electrocardiogram will be recorded at screening and at the end of treatment and at the post-study visit.

Recording of Adverse Events

The reporting and observation of adverse events will occur continually throughout the trial and at the post-study visit. Adverse events will be graded according to the National Cancer Institute (NCI) Common Toxicity Criteria (CTC version 3).

Other Tests

Any other investigations thought relevant to the subject's care may be conducted, if deemed necessary.

### Blinding

The study will be a double blind cross-over randomized non-inferiority comparison of the effect of two sources of G-CSF SC injection in restoring various bone marrow functions following myelosuppressive chemotherapy.

The two sources of G-CSF injection will be designated Drug A or Drug B. The subjects will be randomly allocated using computer generated random numbers to a sequence (ABAB, ABBA, BAAB, BABA, AABB or BBAA) and will receive either Drug A or Drug B in accordance with their sequence.

Subject treatment will remain blinded to the Investigator throughout the study unless the subject experiences a life-threatening event which would require knowledge of the nature of the treatment for ongoing subject management.

### 3. Treatments and Study Procedures

### Neukine®

The drug substance (filgrastim) is manufactured by recombinant DNA technology in an E. coli system. G-CSF is identical to natural human G-CSF except it has an additional methionine at the N-terminal end and is unglycosylated.

Neukine® should be stored in the refrigerator at 2° to 8° C. (36° to 46° F.) and shaking should be avoided. Prior to injection, Neukine® may be allowed to reach room temperature for a maximum of 24 hours. Any pre-filled syringe left at room temperature for greater than 24 hours should be discarded.

Each syringe will be labelled with the allocated subject number of the individual Subject, concentration, dosage instruction, and storage instruction.

Syringes are to be returned to the hospital pharmacy at the conclusion of each treatment cycle. In the event of an SAE, the lot/batch number of drug product used will be recorded.

—Dosage and Administration

Neukine® will be administered (5 μg/kg/day SC rounded up to the nearest syringe size) starting on the day following completion of each cycle of chemotherapy as per NCCN guidelines.

### Neupogen®

The drug substance (filgrastim) is manufactured by recombinant DNA technology in an E. coli system. G-CSF is identical to natural human G-CSF except it has an additional methionine at the N-terminal end and is unglycosylated. It will be supplied as a single-dose, prefilled syringe of 1 ml containing 300 meg of rHu G-CSF in an acetate buffer containing sorbitol and polysorbate 80 at pH4.0.

Unopened syringes are to be stored in the refrigerator at 2° to 8° C. (36° to 46° F.) in accordance with the instructions on the label, as recommended by the manufacturer and shaking is to be avoided. Prior to injection, Neupogen® may be allowed to reach room temperature for a maximum of 24 hours. Any prefilled syringe left at room temperature for greater than 24 hours should be discarded. Each syringe will be labelled with the allocated subject number of the individual subject, concentration, dosage instruction, and storage instructions.

Syringes are to be returned to the hospital pharmacy at the conclusion of each treatment cycle. In the event of an SAE, the lot/batch number of drug product used will be recorded.

—Dosage and Administration

Neupogen® will be administered (5 μg/kg/day SC rounded up to the nearest syringe size) starting on the day following completion of each cycle of chemotherapy as per NCCN guidelines.

### Prior and Concomitant Therapy

Subjects must be off-treatment with any investigational agents for 4 weeks. As much as possible, subjects should minimise any other medication during the treatment period, although this is at the discretion of the Principal Investigators. The use of any concomitant medications administered to subjects during the study must be recorded on the appropriate Case Report Forms (CRFs); in particular use of corticosteroids and dose will be recorded. All cytotoxic therapy and study drug therapy will be administered using evidence-based medicine; currently all cytotoxic protocols at MHS have the relevant references assigned. Drugs which may potentiate the release of neutrophils, such as lithium, should be used with caution.

### 4. Efficacy Evaluations and Endpoints

### Evaluations

Absolute neutrophil count (ANC) will be measured prior to chemotherapy treatment (2 hours before dose), prior to G-CSF administration and thereafter daily from day 1 until the post chemotherapy nadir has passed and the subject's ANC is greater than 1.5×10⁹/L to Day 14, whichever occurs first.

### Endpoints

The following primary efficacy endpoints will be analysed, time to restoration of absolute neutrophil count (ANC)>1.5×10⁹/L, or the duration of Grade 4 Neutrophilia (ANC<0.5×10⁹/L) following chemotherapy Cycle 1.

The following secondary endpoints will be analysed, duration of hospital stay due to neutropenia without fever, and prevention of neutropenia subsequent to first episode.

Other efficacy endpoints include: the duration of Grade 4 neutropenia in chemotherapy cycles 2 to 4, the depth of the nadir in each of the cycles, and the time to ANC recovery (ANC 1.5×10⁹/L) in cycles 1-4.

Various other parameters will also be analysed, including the presence of infection, antibiotic usage, hospitalization requirements, time between chemotherapy cycles, and side effects.

### 5. Safety Evaluations

Safety will be assessed on the basis of physical examination and clinical laboratory tests and will be graded according to the National Cancer Institute (NCl) Common Toxicity Criteria (CTC version 3). The incidence of adverse events will also be assessed.

### Evaluations and Procedures

—Screening Visit

The purpose and procedures of the study will be fully explained to participants. Those wishing to enroll in the study will sign a written informed consent prior to initiating any evaluations or procedures. Enrolled subjects will be entered into the enrolment log and assigned a unique identifying number. The first subject number will be 001; the next subject will be 002, etc.

The screening visit should occur less than 28 days before the commencement of Cycle 1 of chemotherapy treatment. The following procedures are to be done at the screening visit: Review and sign Informed Consent Form, Review Inclusion and Exclusion Criteria, Review and record medical history including previous anti-cancer therapy, Physical examination, Electrocardiogram, Determination of ECOG Performance Score, Vital signs (height, weight, blood pressure, pulse rate, respiration rate and body temperature), Full blood count-FBC: (i.e: red blood cells, haemoglobin, haematocrit, MCV, MCH, Reticulocytes, leucocytes (total and differential) and platelets) Serum chemistry panel: (i.e: sodium, potassium, calcium, phosphate, chloride, bicarbonate, blood urea nitrogen, creatinine, glucose, and cholesterol (total, LDL, HDL)), Liver Function Tests (i.e: total protein, albumin, bilirubin (total), aspartate transaminase (AST), alanine transaminase (ALT), and alkaline phosphatase (ALP), INR, APTT), Urinalysis (i.e: dipstick tests for pH, protein, glucose, ketones, bilirubin, blood, urobilinogen, nitrite, leukocyte esterase), Record all concomitant medications and a pregnancy test (if applicable).

—Procedures During Treatment

The following procedures should be completed before each chemotherapy treatment: Vital signs (weight, blood pressure and pulse rate), Full blood count (FBC) including ANC, Serum chemistry panel, Liver Function Tests, INR, APTT and Recording of concomitant medications.

The following procedures should be completed during each chemotherapy treatment: Assessment of adverse events/toxicity and Recording of concomitant medications.

The following procedures should be completed before each treatment with G-CSF: Full blood count (FBC) including ANC, Liver Function Tests, INR, APTT and Recording of concomitant medications.

The following procedures should be completed during each treatment with G-CSF on days 1-14 or until the post chemotherapy nadir has passed and subjects' ANC is greater than 1.5×10⁹/L, whichever occurs first: Full blood count (FBC) including ANC and an assessment of adverse events/toxicity and recording of concomitant medications.

The following procedures should be completed at the end of each treatment with G-CSF or when the subject is withdrawn early from the trial: Vital signs (weight, blood pressure, pulse rate, respiration rate and body temperature), Physical examinations, Electrocardiogram, Determination of ECOG Performance Score, Full blood count (FBC) including ANC, Serum chemistry panel, Liver Function Tests, Recording of concomitant medications, and an assessment of adverse events/toxicity.

—Evaluations and Procedures Post-Treatment (Post-Study Visit)

Subjects will be required to return to the clinic approximately 30 days after the termination of the study for a follow-up visit. The following performed at the Post-study visit: Assessment of adverse events/toxicity, Recording of concomitant medications, Determination of ECOG Performance Score, Physical examination including electrocardiogram, Vital signs (weight, blood pressure, pulse rate, respiration rate and body temperature), Full blood count (FBC), Serum chemistry panel, Liver Function. Tests, .INR, APTT, Urinalysis and if applicable a pregnancy test.

### Clinical Monitoring

The Sponsor will provide clinical monitoring services and data management services as required. There will be an initiation visit and a study closeout visit. Clinical monitors will review documentation to confirm that the study is being conducted in compliance with the clinical study protocol and ICH-GCP.

### Clinical Laboratories

Clinical laboratory tests will be performed by laboratories accredited by the Study Site.

### Premature Discontinuation

Subjects may be withdrawn from study medication for the following reasons:
at their own request or at the request of their legally authorised representative,
if, in the opinion of the Principal Investigators, continuation in the study would be detrimental to the Subject's well-being, and
at the specific request of the Sponsor.

Subjects must be withdrawn from the study medication under the following circumstances:
intolerable treatment-emergent adverse events as determined by the Principal Investigators and/or subject; or
any event that in the judgment of the Principal Investigators poses an unacceptable safety risk to the subject.

In all cases, the reason for withdrawal must be recorded in the CRF and in the subject's medical records. The subject must be followed up to establish whether the reason was an adverse event, and, if so, this must be reported in accordance with the procedures set out under the heading “notification about serious or unexpected adverse events.”

In all cases, the reason for withdrawal must be recorded in the CRF and in the subject's medical records. The subject must be followed up to establish whether the reason was an adverse event, and, if so, this must be reported in accordance with the protocol procedures.

### Protocol Revisions and Violations

With the exception of emergency situations, no changes or deviations in the conduct of this protocol will be permitted without the prior documented approval of the Sponsor. The Hospital Ethics Committee (HEC) will be notified of all changes in the protocol, and must provide documented approval of any change or deviation that may increase risk to the Subject, and/or that may adversely affect the rights of the Subject or validity of the investigation.

In the event of an emergency, the Principal Investigators will institute any medical procedures deemed appropriate. However, all such procedures must be promptly reported to the Sponsor, the Medical Monitor, and the HEC.

### Compliance

This study will be conducted in accordance with the protocol and Good Clinical Practice-ICH guidelines.

### Adverse Events

An adverse drug event (AE) is any untoward medical occurrence in a subject or clinical investigation subject administered a pharmaceutical product (including up to 30 days following cessation of treatment with the drug), whether or not considered drug related, including those occurring from drug overdose whether accidental or intentional, from drug abuse or from drug withdrawal.

An adverse event can therefore be any unfavourable and unintended sign (including an abnormal laboratory finding), symptom, or disease temporally associated with the use of the drug(s), whether or not considered drug related.

Adverse events either reported by the Subject or observed by the Investigator will be listed individually on an adverse event form in the CRF. The signs and symptoms, time of onset and resolution, duration, treatment (if any), and follow-up procedures (if any) will be reported and the relationship (Table 3), severity (Table 4) action taken (Table 5) and outcome to date should be defined (Table 6). All adverse events are to be followed up for 30 days or until resolution (whichever is sooner).

TABLE 3
Definition of Relationship to Study Drug

| | |
|---|---|
| Definitely | The adverse event: |
| | follows a reasonable temporal sequence from drug |
| | administration |
| | abates upon discontinuation of the study drug |
| | is confirmed by reappearance of the reaction on repeat |
| | exposure (re-challenge) |
| Probably | The adverse event: |
| | follows a reasonable temporal sequence from study drug |
| | administration |
| | abates upon discontinuation of the study drug |
| | cannot be reasonably explained by the known |
| | characteristics of the Subject's clinical state |
| Possibly | The adverse event: |
| | follows a reasonable temporal sequence from study drug |
| | administration |
| | could have been produced by the Subject's clinical state |
| | or by other modes of therapy administered to the Subject |
| Unlikely | The temporal association between the adverse event and the |
| | study drug is such that the study drug is not likely to have had |
| | any reasonable association with the observed event. |
| Unrelated | The adverse event is definitely produced by the Subject's |
| | clinical state or by other modes of therapy administered to the |
| | Subject. |

TABLE 4
Definition of Severity of adverse changes in physical signs or symptoms

| | |
|---|---|
| Mild | Awareness of signs or symptoms, but they are easily tolerated |
| Moderate | Enough discomfort to cause interference with usual activity |
| Severe | Incapacitating, with inability to work or do usual activity |

TABLE 5
Action Taken

| | |
|---|---|
| None | No action taken |
| Discontinued | The study drug was stopped but after the Subject's |
| Temporarily | symptoms abated the Subject was re-challenged with |
| | the study drug |
| Discontinued | The study drug was stopped permanently |
| Permanently | |

TABLE 6
Outcome to Date

| | |
|---|---|
| Recovered | The Subject has fully recovered from the adverse |
| | event with no residual effects observable |
| Recovered with | The subject has recovered from the adverse event, |
| Sequalae | however there are residual effects observable |
| Ongoing | The adverse event is still present and observable |
| Death | The Subject died as a result of the adverse event |
| Unknown | The outcome of the adverse event is unknown at the |
| | time of report |

A serious adverse event (SAE) experience or reaction is any untoward medical occurrence that at any dose: results in death, is life-threatening (places the subject at immediate risk of death), requires in subject/subject hospitalization or prolongation of existing hospitalization, results in persistent or significant disability, incapacity, or is a congenital anomaly/birth defect.

The definition of serious adverse event (experience) also includes important medical events. Medical and scientific judgment should be exercised in deciding whether expedited reporting is appropriate in other situations, such as important medical events that may not be immediately life-threatening or result in death or hospitalization but may jeopardise the subject or may require intervention to prevent one of the other outcomes listed in the definition above. These should also usually be considered serious. Examples of such events are intensive treatment in an emergency room or at home for allergic bronchospasm; blood dyscrasias or convulsions that do not result in hospitalization; or development of drug dependency or drug abuse.

Any of the following events that results in hospitalisation or prolongation of an existing hospitalisation will not be serious adverse event: administration of chemotherapy, administration of study procedures, placement of a permanent intravenous catheter, hospice placement for terminal care, pre-study scheduled elective surgery, outpatient hospitalization for procedures such as elective day surgery, or convenience purposes, e.g. transportation difficulties. These events should be recorded in the CRF.

An unexpected adverse drug event is any adverse event, considered to be associated with the drug therapy, the specificity or severity of which is not consistent with information in the current Investigator's brochure.

A life-threatening adverse drug event is any adverse event that places the subject, in the view of the investigator, at immediate risk of death from the reaction as it occurred, i.e., it does not include a reaction that, had it occurred in a more severe form, might have caused death. Serious adverse events include those that occur anytime after inclusion of the subject in the study up to 30 days after the subject completed (as defined by the protocol) or discontinued the study.

Notification about Serious or Unexpected Adverse Events

All serious and/or unexpected adverse drug experiences or life-threatening toxicities or any fatal event, occurring within 30 days of the last treatment, are to be reported. This includes serious, related, labelled (expected) and serious, related, unlabeled (unexpected) adverse experiences. Serious adverse events occurring beyond one month after completion of the last treatment dose will, in general, not be reported unless the investigator feels that the study drug or a protocol procedure may have caused the event. The following procedures are to be followed.

Within 24 hours of the investigator being made aware of the event, the event is to be reported to the Sponsor Medical Monitor by facsimile or e-mail within 24 hours of awareness of the event, regardless of the time that may have elapsed from the time the event occurred. The sponsor will communicate with the site in order to clarify any queries and to confirm the relationship of the event to the study medication within three days. Within ten working days, a written report will be sent by the Principal Investigator to the HEC.

The Sponsor will report any serious adverse events to the TGA according to the algorithm contained in “Access to Unapproved Therapeutic Goods—Clinical Trials in Australia” (May 2004), which is incorporated herein by reference.

Fatal or life-threatening unexpected SAEs should be reported to the TGA (e.g., by telephone, facsimile transmission, or in writing) as soon as possible but no later than 7 calendar days after first knowledge by the sponsor that a case qualifies, followed by as complete report as possible within 8 additional calendar days. This report must include an assessment of the importance and implication of the findings, including relevant previous experience with the same or similar medicinal products. All other serious and unexpected adverse events judged related to study medication must be sent to the TGA.

The investigator should notify the Institutional Ethics Committee of serious adverse events occurring at the site, in accordance with local procedures. All serious and medically significant adverse events considered related to G-CSF by the Investigator will be followed until resolution or considered stable. Any pregnancy occurring during this study should be immediately reported. Adverse events either reported by the Subject or observed by the Investigator will be listed individually on an adverse event form in the CRF and on the SAE report form. The signs and symptoms, time of onset and resolution, duration, treatment (if any), and follow-up procedures (if any) will be reported and the relationship (Table 3), severity (Table 4), action taken (Table 5) and outcome to date should be defined (Table 6).

It will be left to the investigator's clinical judgment whether or not an adverse event is of sufficient severity to require that the subject should be removed from treatment. A subject may also voluntarily withdraw from treatment due to what he or she perceives as an intolerable adverse event. If either of these occurs, the subject must undergo an end-of-study assessment and be given appropriate care under medical supervision until symptoms cease or the condition becomes stable.

### Independent Data Monitoring Committee

The Independent Data Monitoring Committee (DMC) will be formed to review and evaluate the safety and clinical data during the trial. The Committee will give recommendations to the Sponsor in regards to safety and efficacy data and further conduct of the trial.

### 6. Ethics

### Hospital Ethics Committee (HEC)

Prior to initiation of the study, copy of the protocol, amendments to the protocol, proposed informed consent form, other written subject information, any proposed advertising material and any other documents that may be requested to the HEC will be submitted to the respective Human Research Ethics Committee (HREC) or equivalent for written approval. Principal Investigators will keep on file records of approval of all documents pertaining to this study. The HEC will have at all times the right to review all source documents. The HEC will be notified of any amendments to the protocol. Those amendments will require approval of the HEC prior to being incorporated into the study.

### Ethical Conduct of the Study

This trial will be conducted in accordance with the ethical principles that have their origin in the Declaration of Helsinki and that are consistent with the protocol, good clinical practices (GCP), and the applicable regulatory requirements.

### Subject Information and Consent

Before a subject's participation in the trial, the investigator is responsible for obtaining written informed consent from the subject after adequate explanation of the aims, methods, anticipated benefits, and potential hazards of the study and before any protocol-specific screening procedures or any investigational products are administered.

The acquisition of informed consent should be documented in the subjects' medical records, and the informed consent form should be signed and personally dated by the subject and by the person who conducted the informed consent discussion (not necessarily an investigator). The original signed informed consent form should be retained in accordance with institutional policy, and a copy of the signed consent form should be provided to the subject or legally acceptable representative.

The principles of informed consent as specified by ICH-GCP will be followed. Any amendments to the Informed Consent form will need to be approved by, the Sponsor and the HEC. Written consent will be obtained from each subject to be involved in the clinical trial by using the HEC-approved Informed Consent Form. Consent will be verified by the Principal Investigator and a witness.

The subjects will also be instructed that they are free to withdraw their consent and discontinue their participation in the study at any time without prejudice. Prior to the start of the study, the Principal Investigator will provide Sponsor with an actual Informed Consent Form approved by the HEC for use during the study.

At the conclusion of the study, the Principal Investigators shall provide a letter to Sponsor stating that informed consent was obtained in writing from, each of the study Subjects and that the signed Informed Consent Forms will be kept on file at the study site for the required period of time.

### Confidentially

Subject medical information obtained by the study is confidential and disclosure to third parties other than those noted below is prohibited. At the subject's request, medical information may be given to his or her personal physician or other appropriate medical personnel responsible for his or her welfare. Data generated by this study must be available for inspection on request by representatives of FDA and TGA, state and federal health authorities, the Sponsor, and the HEC.

### 7. Data Analysis and Statistical Considerations

### Study Design

The research model is that of a cross over study with two treatments, four periods and six sequences. The subjects will be randomly allocated using computer generated random numbers to sequence (ABAB, ABBA, BAAB, BABA, AABB or BBAA) and will receive either (Drug A) or (Drug B) in accordance with their sequence. Unfortunately, some carryover effects are anticipated. This will be accounted for in the final statistical analysis, which will be a multi-way analysis of variance, partitioning variance according to that of sequence, period, treatment and carryover. Secondary analysis includes other comparisons of measurements and proportions, using confidence intervals of differences as a major method of presentation.

### Determination of Sample Size

The sample size calculation is that for a four-period, two-treatment, and six-sequence bioequivalence non-inferiority crossover study, as described by: Machin, D, Campbell, M, Payers, P & Pinol A 1997, Sample Size Tables for Clinical Studies, 2nd Edition, Blackwell Science, Bath, United Kingdom, pp. 102-104 (IBSN 0-86542-870-0), the contents of which are herein incorporated by reference. For a non-inferiority study, a one sided probability is used and the probability parameters are a Type I Error of 0.5 and a Type II Error of 0.2.

The mean and standard deviation of the number of days to recovery for Neupogen® are 2.44 and 1.9 days respectively. These are obtained from previous clinical experience, and are generally known and accepted. A tolerance (the maximum difference that is considered as clinically irrelevant) of one day is then chosen.

From these parameters a total sample size of forty-nine subjects will be required. However, as the primary outcome variable is not normally distributed, this is increased to fifty-seven using the Asymptotic Relative Efficiency (ARE) for a non-parametric test of 0.864. To maintain a balanced design this must be increased to a multiple of six, producing a sample size of sixty. Given that this is a clinical study in a difficult area, some subject leakage between recruitment and completion may occur, and an attrition rate of 15% is expected which requires an extra nine cases. In an effort to preserve the balanced design, for each case which may drop out an extra six are required, increasing the extra cases to fifty-four. This results in a total sample size of one hundred and fourteen.

### Analyses Population

—Efficacy Population

Intent-to-treat (ITT) population will consist of all subjects who were randomized to receive any of the two treatments. Per-protocol-population (PP) will consist of all subjects who were randomized to receive any of the two treatments and who had no significant protocol violations.

—Safety Population

Subjects receiving at least one dose will be included in the safety population.

### Efficacy Endpoints

The following primary efficacy endpoints will be analysed:
time to restoration of absolute neutrophil count (ANC)>1.5×10⁹/L
the duration of Grade 4 Neutrophilia (ANC<0.5×10⁹/L) following chemotherapy Cycle 1.

The following secondary endpoints will be analysed:
duration of hospital stay due to neutropenia without fever
prevention of neutropenia subsequent to first episode.

Other efficacy endpoints include:
the duration of Grade 4 neutropenia in chemotherapy cycles 2 to 4,
the depth of the nadir in each of the cycles and
the time to ANC recovery (ANC 1.5×10⁹/L) in cycles 1 to 4.

Various other parameters will also be analysed, including:
the presence of infection,
antibiotic usage,
hospitalization requirements,
time between chemotherapy cycles, and
side effects.

Some carryover effects are anticipated. This will be accounted for in the final statistical analysis, which will be a multi-way analysis of variance, partitioning variance according to that of sequence, period, treatment and carryover. Secondary analysis includes other comparisons of measurements and proportions, using confidence intervals of differences as a major method of presentation.

### Safety End Points

Toxicities will be classified by type, grade, and summarised on a subject and treatment regimen basis. Descriptive statistics, where appropriate, will be used to describe data.

### Statistical Analysis

The standard mixed design, a combination of cross over and repeated measure design, will be used, and the primary analysis will be a two way analysis of variance (ANOVA), the factors being cycles of chemotherapy and the two treatment arms. Following the analysis, the difference between the two treatments and the 95% confidence interval of that difference will be compared against the null and tolerance values, to evaluate whether the hypothesis of non-inferiority has been supported by data. Such techniques will be appreciated by those skilled in the art.

### Data Quality Assurance

Quality assurance (QA) procedures are designed to ensure complete, timely, and accurate submission of data, and that protocol requirements and complications and/or adverse reactions are immediately identified. QA inspections will be carried out during the study by the Sponsor.

### Retention of Study Records

The Principal Investigator will retain copies of the approved protocol, completed CRFs, informed consent documents, relevant source documents, and all other supporting documentation related to the project for a period of at least 2 years after the last approval of a marketing application in an ICH region or at least 2 years after the formal discontinuation of the clinical development of the investigational product. These documents may be retained for a longer period by agreement with the Sponsor. These files must be made available for inspection upon reasonable request by authorised representatives of the Sponsor and the corresponding regulatory agencies of the USA and Australia for the purposes of regulatory approval.

The Sponsor will provide the Principal Investigators with information concerning the current status of the investigational drug as it relates to the Investigator's obligation for the retention of study records. The Investigators should contact the Sponsor prior to disposing of any such records. The Sponsor will arrange for continued storage of all records, if necessary.

### Case Report Forms

There will be primary documentation for all data, and data will not be recorded directly onto the Case Report Forms (CRFs) without such primary documentation. The source data will include such documents as clinical notes, laboratory result sheets, radiology results etc., and will be retained in each subject's file notes. CRFs will be provided by the Sponsor.

The Principal Investigator will be responsible for the timeliness, completeness, and accuracy of the information on the CRF. All entries must be legibly recorded in black ink, with cross-outs initialled and dated but not erased, overwritten, or correction fluid used on the original.

The Principal Investigators will make these forms available for review and collection by the designated Sponsor's representative at each scheduled monitoring visit.

The Principal Investigators will retain a file copy of each completed CRF. In addition, the Investigator or designated colleagues will provide access to the designated Sponsor Medical Monitor or representative(s) for the periodic review of source documents (e.g., hospital and clinic records) to assure accuracy and completeness of the CRFs.

### 8. Reporting of Study Results

### Final Report

After completion or termination of the study, the Principal Investigator will submit a summary report to both the HEC and the Sponsor. Suggested inclusions in the report are: study objectives, methods (including any deviation from the study protocol), evaluation of the study results, observations by the investigator as to the safety and tolerance of the study drug, and a discussion of all adverse events and laboratory abnormalities.

If these products are shown to be clinically equivalent, i.e., Neukine® is not worse than Neupogen®, it is expected that the wider use of G-CSF as either adjuvant or prophylactic therapy in systemic cancer chemotherapy might therefore become economically justifiable. For an environment such as Australia, it is thought that such a result will allow the marketing of the product (g-CSF in this instance) and allowing the Pharmaceutical Benefits Advisory Committee (PBAC) to recommend payment by the Government on the basis that the FOB and the innovator product are interchangeable at a hospital, state or formulary level. This is distinct from the current situation regarding generic products where such products are held to be interchangeable (or substitutable) at a Pharmacy level.

As will be appreciated from a reading of the foregoing, access to certain biologic products is severely limited due to cost. Embodiments of the invention may enable greater access to generic versions of such biologic drugs than previously available.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

1. A method of managing a clinical trial where the clinical trial involves a follow-on biological (FOB) substance, the method comprising:
receiving subject data at a computer system as the subject data becomes available, the subject data indicating effects of the administration of the FOB substance in the clinical trial;
storing the subject data in a database; and
making coded data electronically available to an authorised independent monitor, the coded data being based on the subject data and indicating effects of the administration of the FOB substance in the clinical trial but having subject-identifying information omitted therefrom, wherein the coded data is made available once the subject data is stored in the database.

2. The method of claim 1, wherein the subject data is not made available to the authorised independent monitor.

3. The method of claim 1, further comprising processing the subject data or the coded data to determine non-inferiority or equivalence of the FOB to an innovator biologic substance.

4. The method of claim 3, further comprising determining non-inferiority of the FOB substance if the coded data or subject data indicate that effects of the FOB substance are within a pre-specified non-inferiority margin relative to the innovator biologic substance.

5. The method of claim 4, wherein the determining comprises computing a confidence interval on π_{Innovator}−π_{FOB} based on a null hypothesis of π_{Innovator}≦π_{FOB}−δ and comparing an upper bound of the computed confidence interval to −δ, where δ is the non-inferiority margin, π_{FOB} is the success rate of the FOB substance and π_{Innovator} Innovator is the success rate of the innovator biologic substance.

6. The method of claim 5, wherein the confidence interval is a two-sided a-level confidence interval.

7. The method of claim 1, wherein the authorised independent monitor is independent of management of the clinical trial and is authorised to instruct termination of the clinical trial where, during the clinical trial, the authorised independent monitor determines that the coded data indicate inadequate effects from the administered FOB substance.

8. The method of claim 1, wherein making the coded data available comprises transmitting the coded data to the authorized independent monitor, wherein the coded data is transmitted in response to a request from the authorized independent monitor.

9. (canceled)

10. The method of claim 1, wherein making the coded data available comprises allowing the authorised independent monitor on-demand access to the coded data.

11. The method of claim 1, wherein receiving the subject data at a computer system comprises receiving the subject data at a server system in communication with one or more computers at a site conducting the clinical trial, wherein the subject data is input to the one or more computers at the site for communication of the subject data to the server system over a network.

12. (canceled)

13. (canceled)

14. The method of claim 10, wherein the authorised independent monitor comprises a monitor computer system in communication with the server system over a network.

15. The method of claim 1, further comprising enrolling screened trial subjects into the clinical trial and conducting the clinical trial.

16. The method of claim 1, wherein the clinical trial is a non-inferiority trial.

17. The method of claim 1, further comprising processing the coded data or the subject data to determine whether, as the subject data is received during the clinical trial, the coded data or subject data indicate inadequate effects from the administered FOB substance.

18. A computer implemented method to conduct a clinical trial, the method comprising:
storing clinical trial data of subjects in an ongoing clinical trial that concerns the efficacy of a follow-on biological (FOB); and
providing an independent monitor with substantially continual access to the clinical trial data, whereby said independent monitor may monitor whether said clinical trial data meets predetermined criteria.

19. The method of claim 18, wherein a condition of ongoingness of the clinical
trial is conditional on the clinical trial data having been determined to meet the predetermined criteria.

20. The method of claim 18, wherein the method further comprises performing statistical analysis on said clinical trial data.

21. The method of claim 18, wherein the method further comprises determining a margin of non-inferiority of the FOB and determining whether effects of the FOB are within the margin of non-inferiority.

22. The method of claim 18, wherein the clinical trial data is stored in a database as it is made available from the clinical trial and the clinical trial data is made available to the independent monitor.

23. The method of claim 18, wherein the clinical trial is a non-inferiority trial or an equivalence trial.

24. A system used in managing a clinical trial where the clinical trial involves trialling a follow-on biologic (FOB) substance, the system comprising:
a computer system to receive subject data as the subject data becomes available, the subject data indicating effects of the administration of the FOB substance in the clinical trial; and
a database storing the subject data;
wherein the computer system has access to the database to store and retrieve the subject data and controls access to the database; and
wherein the computer system is configured to make coded data electronically available to an authorised independent monitor, the coded data being based on the subject data and indicating effects of the administration of the FOB substance in the clinical trial but having subject-identifying information omitted therefrom, wherein the computer system is configured to make the coded data available to the authorised independent monitor once the subject data is stored in the database.

25. The system of claim 24, wherein the computer system does not make the subject data available to the authorised independent monitor.

26. The system of claim 24, wherein the computer system is configured to process the subject data or the coded data to determine non-inferiority or equivalence of the FOB to an innovator biologic substance.

27. The system of claim 26, wherein the computer system is configured to determine non-inferiority of the FOB substance if the coded data or subject data indicate that effects of the FOB substance are within a pre-specified non-inferiority margin relative to the innovator biologic substance.

28. The system of claim 27, wherein the computer system determines non-inferiority by computing a confidence interval on π_{Innovator}−π_{FOB} based on a null hypothesis of π_{Innovator}≦π_{FOB}−δ and comparing an upper bound of the computed confidence interval to −δ, where δ is the non-inferiority margin, π_{FOB} is the success rate of the FOB substance and π_{Innovator} is the success rate of the innovator biologic substance.

29. The system of claim 28, wherein the confidence interval is a two-sided α-level confidence interval.

30. The system of claim 24, wherein the authorised independent monitor is independent of management of the clinical trial and is authorised to instruct termination of the clinical trial where, during the clinical trial, the authorised independent monitor determines that the coded data indicate inadequate effects from the administered FOB substance.

31. The system of claim 24, wherein the computer system making the coded data available comprises the computer system transmitting the coded data to the authorized independent monitor, wherein the computer system transmits the coded data in response to a request for the coded data received from the authorized independent monitor.

32. (canceled)

33. The system of claim 24, wherein the computer system making the coded data available comprises the computer system allowing the authorised independent monitor on-demand access to the coded data.

34. The system of claim 24, wherein the computer system comprises a server system in communication with one or more computers at a site conducting the clinical trial, wherein the subject data is input to the one or more computers at the site for communication of the subject data to the server system over a network.

35. (canceled)

36. The system of claim 34, wherein the authorised independent monitor comprises a monitor computer system in communication with the server system over a network.

37. The system of claim 24, wherein the clinical trial is a non-inferiority trial.

38. The system of claim 21, wherein the computer system is further configured to process the coded data or the subject data to determine whether, as the subject data is received during the clinical trial, the coded data or subject data indicate inadequate effects from the administered FOB substance.

39.-47. (canceled)
